(19) United States
(12) Patent Application Publication
(10) Pub. No.: US 2024/0399755 A1
(43) Pub. Date: Dec. 5, 2024

(54) INK SUPPLYING MECHANISM AND IMAGE FORMING APPARATUS

(71) Applicant: KYOCERA Document Solutions Inc., Osaka (JP)

(72) Inventor: Masanobu MAESHIMA, Osaka-shi (JP)

(73) Assignee: KYOCERA Document Solutions Inc., Osaka (JP)

(21) Appl. No.: 18/732,553

(22) Filed: Jun. 3, 2024

(30) Foreign Application Priority Data
Jun. 5, 2023 (JP) 2023-092247

(51) Int. Cl. B41J 2/175

(52) U.S. Cl. CPC B41J 2/17596; B41J 2/17566

(57) ABSTRACT

An ink supplying mechanism includes an ink container, a sub tank, a main channel and a branched channel. The ink container contains ink. The sub tank stores the ink supplied from the ink container. The main channel is extended to a downward direction from the sub tank 22 and flows the ink between the ink container and the sub tank. The branched channel is branched from the middle of the main channel and is subjected to hydraulic head pressure of the ink stored in the sub tank in order to supply the ink to a recording head.

### INCORPORATION BY REFERENCE

This application is based on and claims the benefit of priority from Japanese Patent application No. 2023-092247 filed on Jun. 5, 2023, the entire contents of which are incorporated herein by reference.

### BACKGROUND

The present disclosure relates to an ink supplying mechanism for supplying ink to a recording head and an image forming apparatus including this ink supplying mechanism.

Conventionally, an inkjet type image forming apparatus is equipped with a recording head that discharges ink onto a recording medium such as paper, an ink container that contains ink, and a sub tank that stores the ink supplied from the ink container, and uses hydraulic head pressure between the sub tank and the recording head to supply ink to the recording head. In the image forming apparatus, the liquid surface of the ink comes in contact with air in the ink tank, but it is necessary to restrain dissolving of the air in the ink.

For example, a conventional supplying liquid tank unit in an inkjet recording device is equipped with a supplying liquid tank that stores ink to be supplied to a recording head discharging the ink onto a recording medium, and a detection sensor that detects the liquid surface of the ink in the supplying liquid tank. The supplying tank is provided with an inner space having a storage chamber for storing the ink, and an atmospheric release port for making the inner pressure of the inner space equal to atmospheric pressure. The detection sensor has a float that moves up and down according to an ink amount in the storage chamber, and a sensor body that detects the liquid surface of the ink as the float moves up and down. The inner face of the storage chamber is placed in close proximity along the outer peripheral face of the float.

In the conventional image forming apparatus as described above, the speed of air dissolution in the ink can be slowed by bringing the float and the wall of the sub tank into close proximity, but the air dissolved ink diffuses due to the Brownian motion of the liquid. As a result, it is feared that air dissolved ink is supplied to the recording head, and then operation failure of the recording head causing non-discharge of the ink occurs.

In the conventional image forming apparatus as described above, the detection sensor is composed of the float and the sensor body, the inner face of the storage chamber being a sub tank is placed in close proximity along the outer peripheral face of the float, and the sensor body is inserted into the center of the float. However, if the ink in the sub tank is evaporated or thickened due to contact with the float, it is feared that the ink is fixed between the float and the sensor body, or between the inner face of the storage chamber and the outer peripheral face of the float. As a result, it is feared to cause operation failure of the float with respect to the sensor body or operation failure of the float with respect to the storage chamber, and then to cause detection failure. In addition, if thickened or fixed ink gets mixed into a channel from the sub tank to the recording head, it is feared that a nozzle of the recording head is clogged, and then operation failure of the recording head occurs.

### SUMMARY

An ink supplying mechanism in accordance with the present disclosure includes an ink container, a sub tank, a main channel and a branched channel. The ink container contains ink. The sub tank stores the ink supplied from the ink container. The main channel is extended to a downward direction from the sub tank 22 and flows the ink between the ink container and the sub tank. The branched channel is branched from the middle of the main channel and is subjected to hydraulic head pressure of the ink stored in the sub tank in order to supply the ink to a recording head.

An image forming apparatus in accordance with the present disclosure includes the ink supplying mechanism as described above.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a cross-sectional view schematically showing an example of a printer in accordance with one embodiment of the present disclosure.

FIG. 2 is a block diagram schematically showing an example of an ink supplying mechanism of the printer in accordance with one embodiment of the present disclosure.

FIG. 3 is a cross-sectional view schematically showing an example of a sub tank of the printer in accordance with one embodiment of the present disclosure.

FIG. 4 is a block diagram schematically showing a first modified example of the ink supplying mechanism of the printer in accordance with one embodiment of the present disclosure.

FIG. 5 is a block diagram schematically showing a second modified example of the ink supplying mechanism of the printer in accordance with one embodiment of the present disclosure.

### BRIEF DESCRIPTION OF THE INVENTION

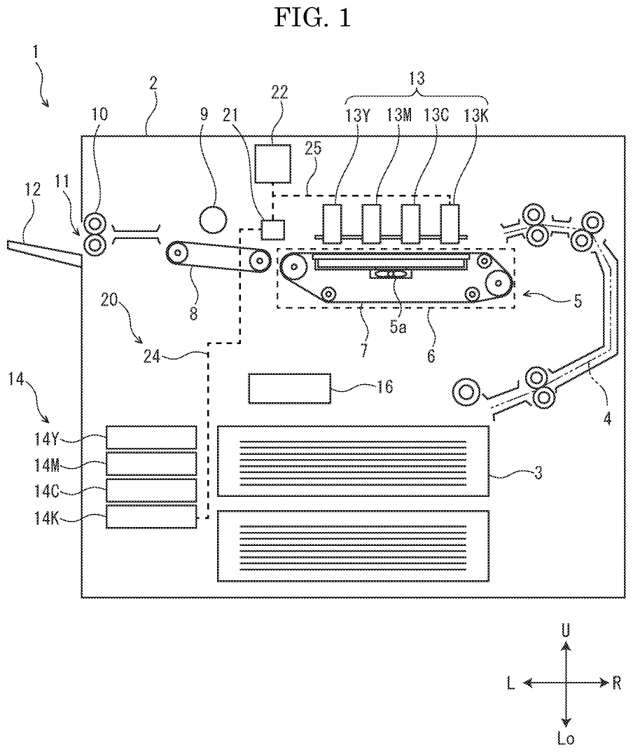

First, the overall configuration of a printer 1 as an inkjet type image forming apparatus will be described with reference to FIG. 1. For convenience of explanation, it will be described so that the front side of the printer 1 is positioned at a near side on a paper sheet of FIG. 1. The arrows L, R, U, and Lo, which are attached to each figure as appropriate, indicate the left side, right side, upper side, and lower side of the printer 1, respectively.

As shown in FIG. 1, the printer 1 includes a box-shape printer body 2. In a lower part of the printer body 2, a sheet feeding cartridge 3 storing sheets is drawably housed.

In a right part inside the printer body 2, a conveyance path 4 of the sheet is arranged and, in a center part inside the printer body 2, the sheet conveying unit 5 is ascendably/descendably arranged above the sheet feeding cartridge 3. The conveyance path 4 is provided from the sheet feeding cartridge 3 to the sheet conveying unit 5 and, along a conveying direction of the sheet through the conveyance path 4, a sheet feeding roller, a conveying roller and a registration roller are located in sequential order from an upstream side.

The sheet conveying unit 5 includes a conveying frame 6 and an endless conveying belt 7 (a conveying member) To the conveying frame 6, a driving roller, a following roller and a tensioning roller are rotatably arranged, and the conveying belt 7 is interchangeably attached to the conveying frame 6 and wound around the drive roller, the following roller, and the tensioning roller. The conveying belt 7 is controlled by a controlling part 16 described below so as to rotate, for example, counterclockwise in the front view, in response to the rotation of the drive roller, and to convey the paper on the conveying belt 7 from the right side to the left side.

The sheet conveying unit 5 is equipped with a lifting mechanism (not shown) that can ascent and descent the conveying frame 6 and the conveying belt 7 in upward and downward directions, and moves the conveying frame 6 and the conveying belt 7 between a print position close to recording heads 13 described below in printing operation and an evacuation position separate from the recording heads 13 in non-printing operation. The sheet conveying unit 5 is also equipped with an air suction part 5a inside the conveying belt 7. The conveying belt 7 is provided with a lot of air suction holes, and the air suction part 5a sucks air from above the conveying belt 7 to the inside via the air suction holes.

In the left part of the printer body 2, a sheet conveying part 8, a drying device 9, and an ejecting roller 10 are provided to the left side of the sheet conveying unit 5 that is at the printing position in order to eject the sheet after printing. On the left side face of the printer body 2, an ejecting port 11 is formed near the ejecting roller 10, and an ejected sheet tray 12 protruding to the left side is provided below the ejecting port 11.

Moreover, inside the printer body 2, four recording heads 13 (13K, 13C, 13M, 13Y) that discharge ink corresponding to the four ink colors of black, cyan, magenta, and yellow, respectively, and four ink containers 14 (14K, 14C, 14M, 14Y) that contain ink are provided. Each recording head 13 is connected to each ink container 14 via an ink supplying mechanism 20 having a suction pump 21 and a sub tank 22. Incidentally, in FIG. 1, the ink supplying mechanism 20 corresponding to black ink is illustrated, and the ink supplying mechanisms 20 corresponding to cyan, magenta, and yellow ink are omitted.

On lower faces of the recording heads 13K, 13C, 13M, 13Y, a plurality of nozzles 13a for discharging ink droplets are formed. The recording heads 13K, 13C, 13M, 13Y are arranged in a line above the sheet conveying unit 5 at the center in the printer body 2, for example, arranged in sequential order from an upstream side (right side) in the conveying direction of the sheet. The recording heads 13K, 13C, 13M, and 13Y face a top face of the conveying belt 7 of the sheet conveying unit 5 during printing operation and discharge black, cyan, magenta, and yellow inks, respectively, onto the sheet on the conveying belt 7.

The ink containers 14K, 14C, 14M, and 14Y are arranged in a line side-by-side in a lower left section of the printer body 2, for example, arranged in sequential order from a lower side. The ink containers 14K, 14C, 14M, and 14Y are, for example, attachably/detachably housed in respective container housing sections (not shown) provided in the lower left section in the printer body 2. The ink containers 14K, 14C, 14M, and 14Y accommodate black, cyan, magenta, and yellow inks, respectively.

Inside the printer body 2, a controlling part 16 is provided to control each part of the printer 1. The controlling part 16 is a computer composed of a central processing unit (CPU) or the like, and controls each part of the printer 1 connected to the controlling part 16 by executing arithmetic process on the basis of control programs and control data stored in a storing part (not shown) composed of ROM, RAM, HDD, or the like.

Next, the details of the ink supplying mechanism 20 will be described.

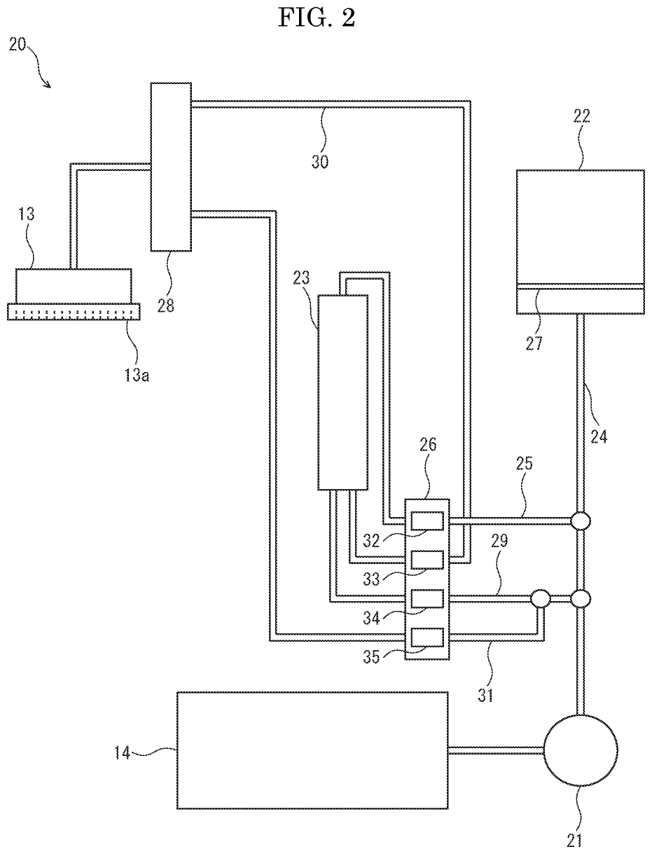

The ink supplying mechanism 20 is a mechanism for supplying the ink from each ink container 14 (14K, 14C, 14M, 14Y) to each recording head 13 (13K, 13C, 13M, 13Y). In the embodiment, as shown in FIG. 2, the ink supplying mechanism 20 is equipped with the suction pump 21, the sub tank 22, a supplying pump 23, a main channel 24, a branched channel 25, a channel opening/closing part 26, a restraining member 27, and a head filter 28. The ink supplying mechanism 20 is configured so as to supply the ink toward the recording heads 13 using the hydraulic head pressure of the ink stored in the sub tank 22.

The ink container 14 is connected to the main channel 24 extending downward from the sub tank 22, and the ink can be flowed between the ink container 14 and the sub tank 22 via the main channel 24. Between the ink container 14 and the sub tank 22, preferably between the suction pump 21 and the sub tank 22, the branched channel 25 is branched from the middle of the main channel 24, and the ink branched from the main channel 24 can be flowed via the branched channel 25. The branched channel 25 is subjected to the hydraulic head pressure of the ink stored in the sub tank 22 in order to supply the ink toward the recording head 13.

The suction pump 23 is composed of a diaphragm pump or the like, and is controlled by the controlling part 16 to supply the ink from the ink container 14 through the main channel 24. The suction pump 21 is provided between the ink container 14 and the sub tank 22 (preferably between the ink container 14 and the branched channel 25) in the main channel 24, and sucks the ink from the ink container 14 and supplies it to the main channel 24.

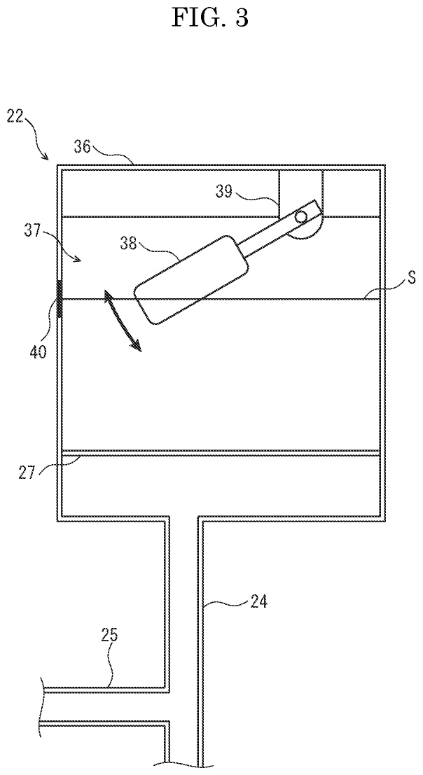

The sub tank 22 stores the ink supplied from ink container 14, and to a lower part (preferably a lower face) of the sub tank 22, the main channel 24 is connected. As shown in FIG. 3, the sub tank 22 is equipped with a tank body 36 and a level sensor 37. The level sensor 37 is composed of, for example, a movable sensor equipped with a float 38, a movable part 39, and a float detection part 40.

The tank body 36 is a housing for storing the ink, and to a lower part (preferably a lower face) of the tank body 36, the main channel 24 is connected. The inside of the tank body 36 is communicated with the main channel 24, and the ink supplied from the main channel 24 is stored in the inside of the tank body 36. In the tank body 36, an upper limit storage amount of the ink, that is, an upper limit level of the liquid surface S of the ink, is set, and the sub tank 22 is controlled so that an ink storage amount (a liquid surface level) is less than the upper limit storage amount (the upper limit level).

The float 38 is supported to move up and down by the movable part 39 at an upper side of the inside of the tank body 36, and is floated on the liquid surface S of the ink stored in the tank body 36 at a position away from an inner wall face of the tank body 36 (at a center side of the tank body 36). For example, the float 38 is formed in an elongated shape, a proximal end of which is supported by the movable part 39, and a distal end of which is arranged so as to float on the liquid surface S of the ink. That is, only one portion of the distal end of the float 38 comes in contact with the liquid surface S of the ink.

The movable part 39 is provided at an upper side of the inside of the tank body 36, above the liquid surface S of the ink so that it does not come in contact with the ink stored in the tank body 36, specifically, above the upper limit level set in the tank body 36. The movable part 39 may be provided on a ceiling face of the tank body 36 or may be provided on the inner wall face of the tank body 36. The movable part 39 can rotatably support the proximal end of the elongated float 38, so that the float 38 can rotate up and down using the movable part 39 as a fulcrum.

The float detection part 40 detects the level of the liquid surface S of the ink stored in the sub tank 22 by detecting the float 38 that is movable up and down. For example, a detected part such as a magnet is provided at the distal end of the float 38, and the level sensor 37 detects the level of the ink stored in the tank body 36 by detecting the detected part of the float 38 by the float detection part 40 provided on the side face (e.g., the inner wall face) of the tank body 36.

The sub tank 22 is controlled by the controlling part 16 to control the ink storage amount of, i.e., the level (height) of the liquid surface S of the ink, so that a hydraulic head difference with the recording head 13 becomes a predetermined set value on the basis of the level of the liquid surface S of the ink detected by the float detection unit 40. Incidentally, the upper limit level of the tank body 36 is set above the ink liquid surface level that achieves the hydraulic head difference of the predetermined set value, and the tank body 36, the float 38 and the movable part 39 may be designed so that the float 38 that has moved to the upper limit level does not come in contact with the ceiling face of the tank body 36.

The supplying pump 23 is composed of a syringe pump or the like and is controlled by the controlling part 16 to fill a predetermined amount of the ink from the main channel 24 between the ink container 14 and the sub tank 22 and to supply the ink to the recording head 13. With the supplying pump 23, the branched channel 25 is connected, and a filling channel 29 for filling the ink from the main channel 24 and a supplying channel 30 for supplying the ink to the recording head 13 are further connected. Moreover, with the recording head 13, a circulation channel 31 for circulating the ink back to a supplying source is connected, and the circulation channel 31 is connected to the filling channel 29 or the main channel 24.

The channel opening/closing part 26 has a first opening/closing member 32 that opens/closes the branched channel 25, a second opening/closing member 33 that opens/closes the supplying channel 30, a third opening/closing member 34 that opens/closes the filling channel 29, and a fourth opening/closing member 35 that opens/closes the circulation channel 31. The first opening/closing member 32, the second opening/closing member 33, the third opening/closing member 34 and the fourth opening/closing member 35 are controlled by the controlling part 16 to open or close, respectively.

The restraining member 27 restricts ink exchange between the sub tank 22 and the branched channel 25 without changing the hydraulic head pressure and is composed of a porous member, a filter, or the like. The restraining member 27 may be arranged, for example, inside the tank body 36 of the sub tank 22, between a bottom face of the tank body 36 and the liquid surface S of the ink, so as to face each other in upward and downward directions, as shown in FIG. 3. Alternatively, the restraining member 27 may be arranged so as to face each other in an ink flowing direction in the main channel 24 between the sub tank 22 and the branched channel 25 in the middle of the main channel 24, or may be attached to the lower face of the sub tank 22 to which the main channel 24 is connected.

The head filter 28 is provided between the supplying pump 23 and the recording head 13 in the supplying channel 30, just before the recording head 13, and removes foreign matter from the ink supplied to the recording head 13 via the supplying channel 30.

Incidentally, although the embodiment describes an example in which the level sensor 37 for detecting the level of the ink stored in the tank body 36 in the ink supplying mechanism 20 is composed of, for example, a movable sensor equipped with the float 38, the movable part 39, and the float detection part 40, the present disclosure is not limited to this example. In another example, the level sensor 37 may be composed of a fixed sensor equipped with a capacitance sensor, a photo interrupter or an electrode type level sensor. In this case, the level sensor 37 is provided above the upper limit level set in the tank body 36.

Next, an example of the operation of the ink supplying mechanism 20 of the embodiment will be described.

In normal operation, the ink supplying mechanism 20 opens all of the first opening/closing member 32, the second opening/closing member 33, the third opening/closing member 34, and the fourth opening/closing member 35 in the channel opening/closing part 26. Thereby, the hydraulic head pressure of the ink stored in the sub tank 22 acts on the recording head 13 via the main channel 24, the branched channel 25, and the supplying channel 30, and then it is possible to appropriately supply the ink filled in the supplying pump 23 to the recording head 13.

When filling the ink, the ink supplying mechanism 20 opens the third opening/closing member 34, while closes the first opening/closing member 32, second opening/closing member 33 and fourth opening/closing member 35. Thereby, it is possible to fill the ink from the main channel 24 between the suction pump 21 and the sub tank 22 to the supplying pump 23 via the filling channel 29.

When circulation, the ink supplying mechanism 20 opens the second opening/closing member 33 and the fourth opening/closing member 35, while closes the first opening/closing member 32 and the third opening/closing member 34. Thereby, it is possible to circulate the ink from the recording head 13 to the main channel 24 between the suction pump 21 and the sub tank 22 via the circulation channel 31.

When removing air, the ink supplying mechanism 20 opens the first opening/closing member 32, while closes the second opening/closing member 33, third opening/closing member 34 and fourth opening/closing member 35. Thereby, it is possible to remove unnecessary air in the main channel 24, the branched channel 25 and the supplying pump 23.

As described above, the ink supplying mechanism 20 in the printer 1 is equipped with the ink container 14, the sub tank 22, the main channel 24, and the branched channel 25. The ink container 14 contains the ink. The sub tank 22 stores the ink supplied from the ink container 14. The main channel 24 is extended to the downward direction from the sub tank 22 and flows the ink between the ink container 14 and the sub tank 22. The branched channel 25 is branched from the middle of main channel 24 and is subjected to the hydraulic head pressure of the ink stored in the sub tank 22 in order to supply the ink to the recording head 13.

Therefore, if, near the liquid surface S of the ink stored in the sub-tank 22, air is dissolved in the ink or the ink is evaporated or thickened to be fixed, it is possible to restrain the air dissolved ink or the thickened or fixed ink from flowing into the channel for supplying the ink to the recording head 13. Then, it is possible to restrain operation failure of the recording head 13 causing non-discharge of the ink by the air dissolved ink. Moreover, it is possible to restrain operation failure of the recording head 13 clogging of the nozzle 13a of the recording head 13 with the thickened or fixed ink.

In the embodiment, the ink supplying mechanism 20 is equipped with the level sensor 37 that detects the level of the liquid surface S of the ink stored in the sub tank 22. The level sensor 37 is composed of the movable sensor equipped with the float 38 floating on the liquid surface S away from the inner wall face of the sub tank 22 and the movable part 39 provided at a position not in contact with the ink to move the float 38. Alternatively, the level sensor 37 is composed of the fixed sensor equipped with the capacitance sensor, the photo interrupter or the electrode type level sensor provided at a position not in contact with the ink.

Therefore, if, near the liquid surface S of the ink stored in the sub-tank 22, the ink is evaporated or thickened to be fixed, since the thickened or fixed ink does not affect movement of the float 38 against the inner wall face of the sub tank 22 and does not affect movement of the float 38 by the movable part 39, it is possible to restrain effect on detection of the level sensor 37 being the movable sensor. Moreover, since the thickened or fixed ink does not come in contact with the fixed sensor equipped with the capacitance sensor, the photo interrupter or the electrode type level sensor, it is possible to restrain effect on detection of the level sensor 37 being the fixed sensor.

In the embodiment, the ink supplying mechanism 20 is equipped with the suction pump 21 that causes the ink to be supplied from the ink container 14 via the main channel 24, and the branched channel 25 is arranged between the sub tank 22 and the suction pump 21.

Therefore, by simpler configuration, it is possible to apply the hydraulic head pressure of the ink stored in the sub-tank 22 into the recording head 13 via the branched channel 25 without changing the hydraulic head pressure, and to restrain the air dissolved ink or the thickened or fixed ink from flowing into the branched channel 25.

In the embodiment, the ink supplying mechanism 20 is equipped with the restraining member 27 that restricts ink exchange between the sub tank 22 and the branched channel 25 without changing the hydraulic head pressure between the sub tank 22 and the branched channel 25.

Therefore, if, near the liquid surface S of the ink stored in the sub-tank 22, air is dissolved in the ink or the ink is evaporated or thickened to be fixed, it is possible to more restrain the air dissolved ink or the thickened or fixed ink from flowing into the channel for supplying the ink to the recording head 13.

Incidentally, although the embodiment described above describes an example that the ink supplying mechanism 20 is equipped with both the suction pump 21 that sucks the ink from the ink container 14 and the supplying pump 23 that supplies filled ink to the recording head 13, the present disclosure is not limited to this example. In the present disclosure, the ink supplying mechanism 20 need only have a configuration in which the branched channel 25 is branched from the main channel 24 between the ink container 14 and the sub tank 22, and the branched channel 25 is subjected to the hydraulic head pressure of the ink stored in the sub tank 22 in order to supply ink toward the recording head 13, and then, other channels and/or other pumps can be variously combined.

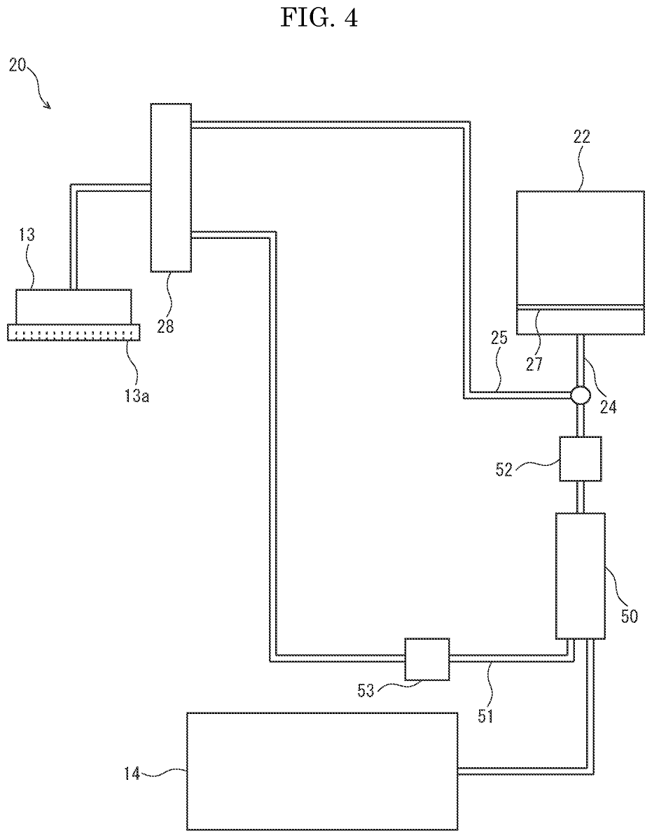

For example, as shown in FIG. 4, in the first modified example, the ink supplying mechanism 20 may be configured to be equipped with only a supplying pump 50 that supplies filled ink to the recording head 13, without the suction pump 21 that sucks the ink from the ink container 14. In the first modified example, the supplying pump 50 such as a syringe pump is provided in the middle of the main channel 24. Between the supplying pump 50 and the sub-tank 22, the branched channel 25 is branched from the middle of the main channel 24, and the branched channel 25 is connected to the recording head 13 via the head filter 28. To the recording head 13, a circulation channel 51 for circulating the ink back to the supplying source is connected, and the circulation channel 51 is connected to the supplying pump 50.

Furthermore, in the middle of the main channel 24, between the supplying pump 50 and the branched channel 25, a fifth opening/closing member 52 is provided to open/close the main channel 24, and in the circulation channel 51, a sixth opening/closing member 53 is provided to open/close the circulation channel 51. The fifth opening/closing member 52 and the sixth opening/closing member 53 are controlled by the controlling part 16 to open or close, respectively.

Next, an example of the operation of the ink supplying mechanism 20 of the first modified example will be described.

In normal operation, the ink supplying mechanism 20 opens all of the fifth opening/closing member 52 and the sixth opening/closing member 53. Thereby, the hydraulic head pressure of the ink stored in the sub tank 22 acts on the recording head 13 via the main channel 24 and the branched channel 25, and then, it is possible to appropriately supply the ink filled in the supplying pump 50 to the recording head 13.

When filling the ink, the ink supplying mechanism 20 closes all of the fifth opening/closing member 52 and the sixth opening/closing member 53. Thereby, it is possible to fill the ink into the supplying pump 50 from the main channel 24 between the ink container 14 and the supplying pump 50.

When circulation, the ink supplying mechanism 20 opens the sixth opening/closing member 53, while closes the fifth opening/closing member 52. Thereby, it is possible to circulate the ink from the recording head 13 to the supplying pump 50 via the circulation channel 51.

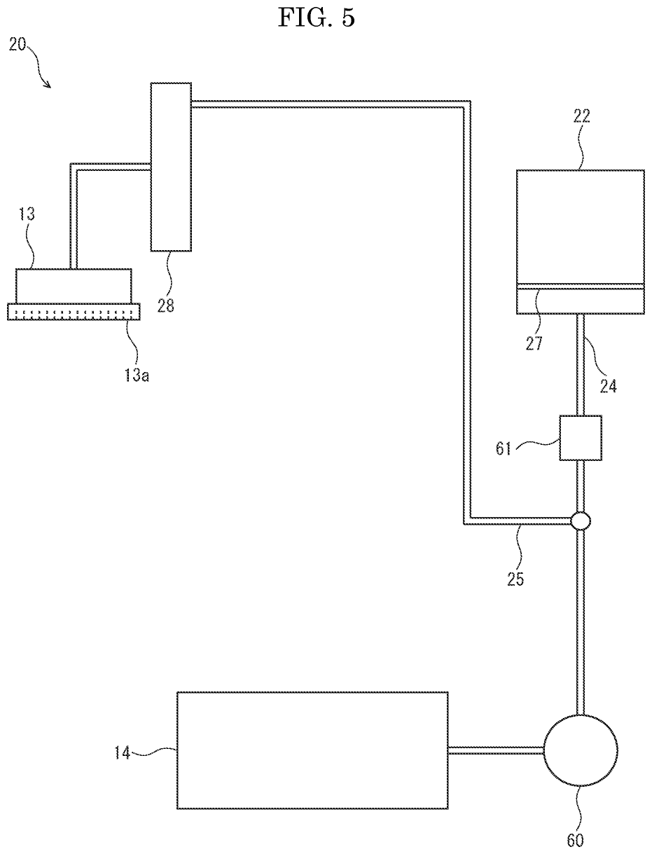

Alternatively, for example, as shown in FIG. 5, in the second modified example, the ink supplying mechanism 20 may be configured to be equipped with the suction pump 60 that sucks the ink from the ink container 14, without the supplying pump 23 that supplies filled ink to the recording head 13. In the second modified example, the suction pump 60 such as a diaphragm pump is provided in the middle of the main channel 24. Between the suction pump 60 and the sub tank 22, the branched channel 25 is branched from the middle of the main channel 24, and the branched channel 25 is connected to the recording head 13 via the head filter 28.

Furthermore, in the middle of the main channel 24, between the sub tank 22 and the branched channel 25, a seventh opening/closing member 61 is provided to open/close the main channel 24. The seventh opening/closing member 61 is controlled by the controlling part 16 to open or close.

Next, an example of the operation of the ink supplying mechanism 20 of the second modified example will be described.

In normal operation, the ink supplying mechanism 20 opens the seventh opening/closing member 61. Thereby, the hydraulic head pressure of the ink stored in the sub tank 22 acts on the recording head 13 via the main channel 24 and the branched channel 25, and by working the suction pump 60, the ink can be supplied to the recording head 13.

In purging process, the ink supplying mechanism 20 closes the seventh opening/closing member 61. Thereby, by working the suction pump 60, the ink can be supplied to the recording head 13 to perform the purging process, without acting the ink on the sub tank 22.

Although the embodiment has been described about a case where a configuration of the present disclosure is applied to the printer 1 as the image forming apparatus, in another embodiment, the configuration of the present disclosure may be applied to another image forming apparatus, such as a copying machine, a facsimile or a multifunction peripheral, as long as it is equipped with the inkjet type ink supplying mechanism.

1. An ink supplying mechanism comprising:
an ink container containing ink;
a sub tank storing the ink supplied from the ink container;
a main channel being extended to a downward direction from the sub tank and flowing the ink between the ink container and the sub tank; and
a branched channel being branched from the middle of the main channel and being subjected to hydraulic head pressure of the ink stored in the sub tank in order to supply the ink to a recording head.

2. The ink supplying mechanism according to claim 1 further comprising:
a level sensor that detects a level of a liquid surface of the ink stored in the sub tank,
wherein the level sensor is composed of a movable sensor equipped with a float floating on the liquid surface away from an inner wall face of the sub tank and a movable part provided at a position not in contact with the ink to move the float, or a fixed sensor equipped with a capacitance sensor, a photo interrupter or an electrode type level sensor provided at a position not in contact with the ink.

3. The ink supplying mechanism according to claim 1 further comprising:
a suction pump that causes the ink to be supplied from the ink container via the main channel,
wherein the branched channel is arranged between the sub tank and the suction pump.

4. The ink supplying mechanism according to claim 1 further comprising:
a restraining member that restricts ink exchange between the sub tank and the branched channel without changing the hydraulic head pressure between the sub tank and the branched channel.

5. An image forming apparatus comprising:
the ink supplying mechanism according to claim 1.
